(19) United States
(12) Patent Application Publication
(10) Pub. No.: US 2023/0145559 A1
(43) Pub. Date: May 11, 2023

(54) OUTDOOR BUILDING MATERIALS INCLUDING POLYMER MATRIX AND FIRST AND SECOND REINFORCEMENT MATERIALS

(71) Applicant: Singular Solutions Inc., North York (CA)

(72) Inventors: Alex Mann, Vaughan (CA); Mirek Planeta, Mississauga (CA); Vladimir Climov, Toronto (CA)

(21) Appl. No.: 17/980,654

(22) Filed: Nov. 4, 2022

Related U.S. Application Data
(60) Provisional application No. 63/276,328, filed on Nov. 5, 2021.

(51) Int. Cl. B32B 27/20; B32B 7/12; B32B 27/08; B32B 27/32; B32B 27/36; B32B 27/30; B32B 27/34; B29C 48/00; B29C 48/21

(52) U.S. Cl. CPC B32B 27/20; B32B 7/12; B32B 27/08; B32B 27/32; B32B 27/36; B32B 27/302; B32B 27/34; B32B 27/308; B32B 27/306; B32B 27/304; B29C 48/022; B29C 48/21; B32B 2307/3065; B32B 2264/108; B32B 2272/00; B32B 2262/0284; B32B 2262/0253; B32B 2262/0261; B32B 2262/062; B32B 2419/00; B29K 2105/26

(57) ABSTRACT

Methods of manufacturing an outdoor building material, and outdoor building materials thereof. A polymer matrix and a first reinforcement material may be provided. The polymeric matrix and the first reinforcement material may be shredded to form a shredded mixture. A second reinforcement material may be combined with the shredded mixture to form a combined mixture. The combined mixture may be heated and extruded to form the outdoor building material, in which the first and second reinforcement materials are dispersed in the polymer matrix. At least a portion of the polymer matrix may be derived from waste agricultural film. At least a portion of the first reinforcement material may be post-consumer waste in the form of clothing, carpet, curtains, fabric, or combinations thereof. The second reinforcement material may consist of at least one of char, biochar, and carbon black.

### CROSS-REFERENCE TO RELATED APPLICATION

This application claims priority to U.S. Provisional Application No. 63/276,328 filed on Nov. 5, 2021, the entire contents of which is hereby incorporated herein by reference.

### FIELD

The present disclosure relates generally to materials suitable for use in outdoor construction. The present disclosure also relates generally to materials having recycled components.

### BACKGROUND

The following paragraphs are not an admission that anything discussed in them is prior art or part of the knowledge of persons skilled in the art.

United States Publication No. 2008/0128933 A1 describes an extruded composite utilized as a building material including a base polymer, unseparated processed recycled carpet waste, and a filler material, which may be a wood filler or other natural fiber. The recycled carpet waste may be used to decrease the amount of both base polymer and wood filler to achieve an equivalent product at lower cost. The extruded composite may also utilize chemical foaming agents to reduce density. Both foamed and non-foamed composites may be capstocked.

United States Publication No. 2012/0031543 A1 describes a method for using discarded carpet segments or other recycled textiles to make wood-like material in sheets that are comparable to plywood. The carpet segments or other recycled materials are shredded, then layered across a slow-moving conveyor to form a thick, low-density belt of fibers. This belt is compressed between rollers, and then needle-punched, using needles with surface barbs that pull fibers downward and upward. This needle-punching causes fibers inside the mat to be pulled into vertical alignment (i.e., perpendicular to the top and bottom surfaces of a horizontal mat), to form a needle-punched mat that will hold together without chemical adhesives. A binder material is then applied to at least one and possibly both surfaces of the mat, by means such as spreading or spraying a liquid binder on either or both surfaces of the mat, or stretching a continuous film of the binder material across either or both surfaces of the mat. The polymer-coated fiber mat is then compressed while the binder hardens and cures, to form hardened wood-like product, in sheet form, without requiring melting of the nylon or other synthetic fibers inside the material. In an alternate embodiment, nylon fibers blended with polypropylene or other polyolefins can be heated and compressed to a temperature which (i) melts the polypropylene, causing it to act as an adhesive, and (ii) creates a “heat set” in the nylon fibers. These materials are strong, durable, highly resistant to cracking or splitting, and highly resistant to water infiltration or damage, and offer highly useful substitutes for plywood, particleboard, and other forms of wood and lumber.

United States Publication No. 2020/0062646 A1 describes construction materials, in particular sustainable construction materials and methods of their preparation and use. Said construction material comprises biochar.

### INTRODUCTION

The following is intended to introduce the reader to various aspects of the present disclosure, but not to define any invention.

In an aspect of the present disclosure, there is a method of manufacturing an outdoor building material. The method may include: providing a polymer matrix; providing a first reinforcement material; shredding the polymeric matrix and the first reinforcement material to form a shredded mixture; providing a second reinforcement material; combining the second reinforcement material to the shredded mixture to form a combined mixture; and extruding the combined mixture to form the outdoor building material, in which the first and second reinforcement materials are dispersed in the polymer matrix.

In an aspect of the present disclosure, an outdoor building material may include: a polymer matrix; a first reinforcement material dispersed in the polymer matrix; and a second reinforcement material dispersed in the polymer matrix. The first reinforcement material consists of a textile material. The second reinforcement material consists of at least one of char, biochar, and carbon black.

Other aspects and features of the teachings disclosed herein will become apparent, to those ordinarily skilled in the art, upon review of the following description of the specific examples of the present disclosure.

### BRIEF DESCRIPTION OF THE DRAWINGS

The drawings included herewith are for illustrating various examples of apparatuses and methods of the present disclosure and are not intended to limit the scope of what is taught in any way. In the drawings:

FIG. 1 is a perspective view of an example of an outdoor building material;

FIG. 2A is a cross-sectional side view of the building material of FIG. 1, along the line 2A-2A in FIG. 1;

FIG. 2B is a cross-sectional top view of the building material of FIG. 1, along the line 2B-2B in FIG. 1;

FIG. 3A is a cross-sectional side view of another example of a building material having a capstock;

FIG. 3B is a cross-sectional side view of another example of a building material having a capstock and a tie layer;

FIG. 4 is a schematic diagram of an example of an extruder used to manufacture an outdoor building material;

FIG. 5 is a schematic diagram of another example of an extruder used to manufacture an outdoor building material; and

FIG. 6 is a flowchart of an example method of manufacturing an outdoor building material.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

In general, the concepts described herein pertain to an outdoor building material and a method of manufacturing the same. The outdoor building material has a polymer matrix, a first reinforcement material, and a second reinforcement material. The first reinforcement material may be a textile material, while the second reinforcement material may be at least one of char, biochar, and carbon black. The first and second reinforcement materials are dispersed in the polymer matrix such that they reinforce the polymer matrix.

The method of manufacturing the outdoor building material may include the steps of providing and shredding the polymer matrix and first reinforcement matrix. The second reinforcement material may then be added to the shredded mixture and the combined mixture may then be extruded to form the outdoor building material.

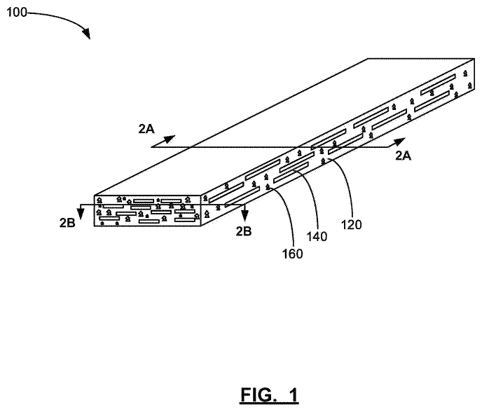

Referring to FIG. 1, an example of an outdoor building material is shown generally as reference number 100. As shown, the building material 100 includes a polymer matrix 120, a first reinforcement material 140, and a second reinforcement material 160. The first reinforcement material 140 and the second reinforcement material 160 are dispersed in the polymer matrix 120. As exemplified, the building material 100 is shown as a plank. It will be appreciated that the building material 100 may be any shape, including, but not limited to, a beam, brick, or a sheet.

The first reinforcement material 140 and the second reinforcement material 160 operate to reinforce the polymer matrix 120, thereby improving the strength of the building material 100. To assist with the reinforcing of the polymer matrix 120, the materials used for each component of the building material 100 may be selected based on melting temperature. Selecting the components based on melting temperature may allow the building material 100 to be manufactured such that the polymer matrix 120 melts during the manufacturing process, while leaving the first reinforcement material 140 and/or second reinforcement material 160 in a solid or semi-solid state. By maintaining the first reinforcement material 140 and/or second reinforcement material 160 in a solid or semi-solid state, the first reinforcement material 140 and/or second reinforcement material 160 may be dispersed throughout the polymer matrix 120 while maintaining the characteristics of each respective material that allows the first reinforcement material 140 and/or second reinforcement material 160 to reinforce the building material 100. For example, when extruding the building material 100, the extruder may be operated to melt the polymer matrix 120, without melting the first reinforcement material 140 and/or second reinforcement material 160.

The first reinforcement material 140 may have a melting temperature that is greater than the melting temperature of the polymer matrix 120. Similarly, the second reinforcement material 160 may have a melting temperature that is higher than the melting temperature of the polymer matrix 120. The second reinforcement material 160 may also have a melting temperature that is higher than the melting temperature of the first reinforcement material 140. Choosing a material for the second reinforcement material 160 that has a melting temperature greater than the melting temperature of the first reinforcement material 140 may improve the strength of the building material 100 by ensuring that there is at least one reinforcement material that remains in a solid state during the extrusion process. For example, extrusion may sometimes result in increased temperatures due to shearing along the interior wall of the extruder. This increased temperature may rise above the melting temperature of the first reinforcement material 140, causing at least some of the first reinforcement material 140 to melt in these regions. By providing a second reinforcement material 160 that has a higher melting temperature than the first reinforcement material 140, the strength in these regions may be generally more consistent since the second reinforcement material 160 does not melt, thereby acting as a safety factor for ensuring the strength of the building material 100.

The polymer matrix 120 may be any material that is capable of melting in an extruder and acting to bind the reinforcement materials together. In some examples, the polymer matrix 120 may be a polyolefin, including, but not limited to, polyethylene (PE), low-density polyethylene (LDPE), high-density polyethylene (HDPE), linear low-density polyethylene (LLDPE), polypropylene (PP), ethyl vinyl acetate (EVA), copolymers thereof, and/or combinations thereof. In some examples, the polyolefin of the polymer matrix 120 may instead be replaced with polystyrene (PS), high impact polystyrene (HIPS), polyvinyl chloride (PVC), acrylic, acrylonitrile butadiene styrene (ABS), copolymers thereof, and/or combinations thereof.

The polymer matrix 120 may be formed of materials that are difficult to recycle, such as materials that have high bulk, low melting temperatures, and/or are partially contaminated. In some examples, at least a portion of the polymer matrix may be derived from one or more of waste agricultural film, mulching films, plastic tarps, plastic bags, plastic waste from construction, post-consumer waste, or combinations thereof. If the material for the polymer matrix 120 is derived from contaminated post-consumer waste, the waste may be washed prior to use. A possible advantage from using agricultural film is that agricultural waste provides a more consistent composition as compared to post-consumer waste. Post-consumer waste may have a mix of different plastics and contaminants that may reduce the likelihood of consistency. A consistent composition may result in the building material 100 having consistent physical properties, such as strength and durability. Consistent building materials are particularly important for the building industry due to the damage to persons and/or property that can result from failure of poor building materials.

The first reinforcement material 140 may be any material that operates to reinforce the polymer matrix 120. The first reinforcement material 140 may be a post-consumer waste material such as a textile. For example, the first reinforcement material may be, including, but not limited to, clothing, carpet, curtains, fabric, or combinations thereof. The textile material may include at least one of polyethylene terephthalate (PET), polypropylene (PP), nylon, and cotton.

The second reinforcement material 160 may also be any material capable of reinforcing the polymer matrix 120. As noted above, the second reinforcement material 160 may have a higher melting temperature than the polymer matrix 120 and/or the reinforcement material 140. For example, the second reinforcement material 160 may include at least one of char, biochar, and carbon black. Char has a porous structure that results from incineration of materials that do not burn completely, or materials that are incinerated in such a manner that there is insufficient oxygen for complete combustion. Biochar is char that is formed from organic materials, such as biomass waste. Carbon black is similarly produced from heavy petroleum products such as FCC tar, coal tar, ethylene cracking tar, or vegetable matter. These materials will collectively be referred to as char.

An advantage of using char in the building material 100 is that char does not melt at higher temperatures. Accordingly, in the event that some or all of the first reinforcement material 140 (e.g., a textile material) melts in the extruder, the second reinforcement material 160 will remain in a solid state to reinforce the building material 100. Alternatively, or in addition, the char may act to stabilize the textile material despite an increased heat in the extrusion process.

Char may have a relatively large surface area and may have a high surface texture. Larger pieces of char may be used in the building material 100. The high surface area and/or texture of char may improve the bonding between the different components in the building material 100. For example, the char may act to improve the entanglement of the textile fibers, thereby improving the mechanical bonding of the textile fibers with the polymer matrix 120. Improving the bonding between the first reinforcement material 140 and the polymer matrix 120 may increase the strength of the building material 100 in multiple directions. For example, the char may improve the strength of the building material 100 in both the longitudinal and transverse directions.

Char has a relatively high degree of porosity and bulkiness, and a relatively low density. Accordingly, using char as the second reinforcement material 160 enables the second reinforcement material 160 to also act as a filler in the building material 100. Using the second reinforcement material 160 as a filler may reduce the amount of polymer matrix 120 and/or first reinforcement material 140 needed to produce the same volume of building material 100. Another advantage is that the relatively low density of char reduces the weight of the building material 100, without compromising the strength of the composite.

Char may also act as a fire block for the building material 100. For example, if the building material 100 is used in a house, the char in the building material 100 may prevent fire from spreading from one room to the next, since char is not combustible.

Another possible advantage of using char as the second reinforcement material 160 is that char may act as a deodorizer for the building material 100. For example, if a textile is used for the first reinforcement material 140, such as clothing, the clothing may have odors from consumer use and/or partial decay of organic fibers. The char may act to remove odors from the building material 100. Accordingly, during the manufacturing process of the building material 100, the first reinforcement material 140 may not need to be washed, since the char can remove the odors from the resultant building material 100, thereby saving time, energy, and money.

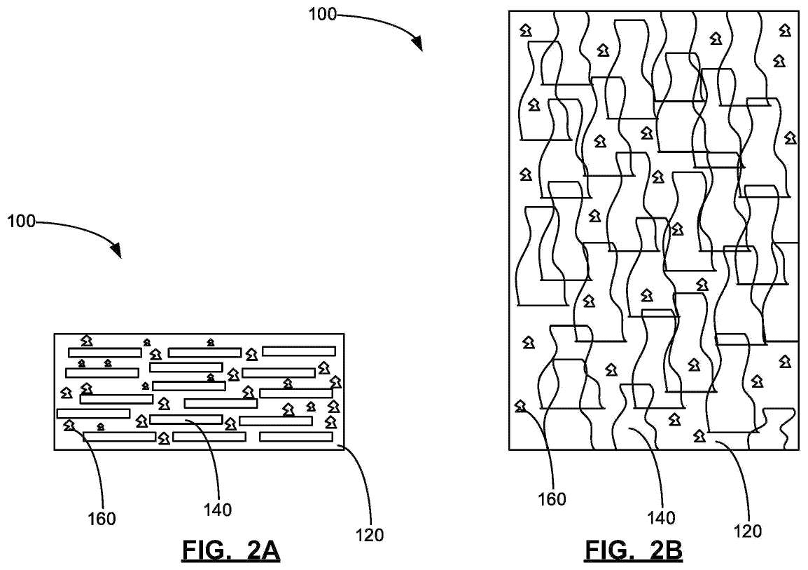

The shape of the first reinforcement material 140 and/or the second reinforcement material 160 may vary depending on the desired use of the building material 100. For example, when the first reinforcement material 140 is a textile, the textile may be in the form of at least one of flakes and fibers. Flakes may be distinguished from fibers in that flakes may have a thickness that is significantly less than the length and width of the flake, whereas fibers have both thickness and width that are significantly less than the length of the fiber. The relatively larger width of the flakes may improve the reinforcement properties of the first reinforcement material 140 in three dimensions, as opposed to two dimensions when a fiber is used. As exemplified in FIGS. 1-3 and more clearly shown in FIG. 2B, the first reinforcement material 140 is in the shape of flakes.

The size of the first reinforcement material 140 and/or the second reinforcement material 160 may vary depending on the desired use of the building material 100. For example, the when the first reinforcement material 140 is a textile material, the textile material may be in the form of pieces having length, width, and height dimensions each between about 0.25 inch to about 1 inch.

The weight percentage of the polymer matrix 120, the first reinforcement material 140, and the second reinforcing material 160 may vary depending on the desired use of the building material 100. For example, the polymer matrix may have a weight percentage in the range of about 30% w/w to about 70% w/w. The first reinforcement material 140 may have a weight percentage in the range of about 30% w/w to about 70% w/w. The building material 100 may have less of the second reinforcement material 160 as compared to the polymer matrix 120 and/or the first reinforcement material 140. For example, the second reinforcement material 160 may have a weight percentage in the range of about 2% w/w to about 20% w/w.

In some examples, the building material 100 may include one or more additional reinforcement materials. For example, there may be a third reinforcement material dispersed in the polymer matrix 120. The third reinforcement material may be any material that reinforces the polymer matrix 120, including, but not limited to high-density polyethylene (HDPE). The HDPE may be derived at least partially from post-consumer waste, such as from plastic water bottles.

In some examples, the building material 100 may include one or more additives for imbuing the building material 100 with additional properties. For example, the building material 100 may include one or more of a foaming agent, a moisture absorbing material, a material for wettability, a flame retardant, or combinations thereof.

When the additive includes a foaming agent, the foaming agent may be, but is not limited to, sodium bicarbonate, liquid natural gas, pentane, nitrogen, carbon dioxide, or combinations thereof.

When the additive includes a moisture absorbing material, the moisture absorbing material may be, but is not limited to, calcium oxide, calcium carbonate, or combinations thereof.

When the additive includes a material for wettability, the material for wettability may be, but is not limited to, polyisobutylene, epoxidized soybean oil, polyglycol, or combinations thereof.

When the additive includes a flame retardant, the flame retardant may be, but is not limited to, phosphate, borate, or combinations thereof.

The building material 100 may include an additive that assists with the stability of the polymer matrix 120. For example, the polymer matrix 120 may include a compatibilizer, including, but not limited to, polyisobutylene, polyisoprene, LLDPE comprising a tackifier, or combinations thereof. In some examples, the polymer matrix 120 may inherently contain a compatibilizer. For example, when an agricultural film is selected for the polymer matrix 120, the agricultural film may inherently include a tackifier such as low molecular weight polyisobutylene. This polymer may act as a compatibilizer when the building material 100 is extruded, thereby assisting with the bonding between the polymer matrix 120, the first reinforcement material 140, and the second reinforcement material 160.

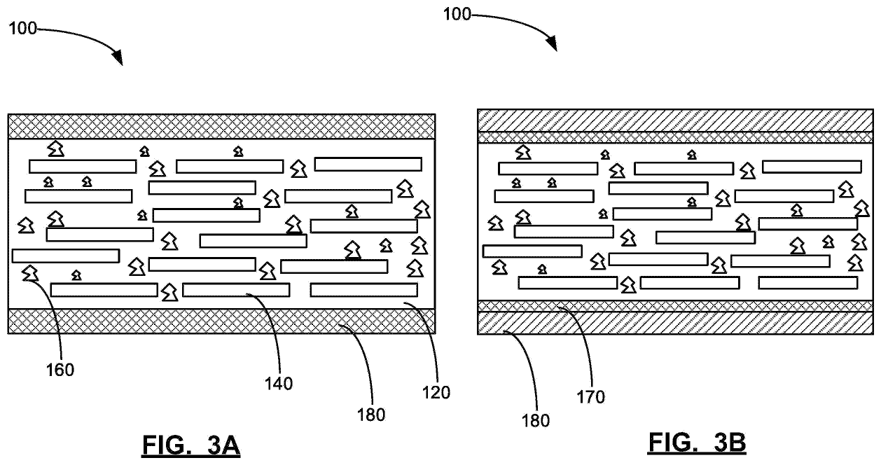

In some examples, the building material 100 may include a capstock 180, as exemplified in FIGS. 3A-3B. The capstock 180 may be formed of, including, but not limited to, HDPE, PET, PVC, PS, HIPS, ABS, nylon, polyacrylate, methacrylate, copolymers thereof, and/or combinations thereof. In some examples, the capstock 180 may include a tie layer 170. The tie layer 170 may improve the bond between the capstock 180 and the polymer matrix 120. For example, the tie layer 170 may be used to couple the capstock 180 to the polymer matrix 120 and improve adhesion therebetween.

The capstock 180 may operate to improve the strength and/or rigidity of the building material 100. The capstock 180 may also be used to alter the surface of the building material 100. For example, the capstock 180 may be embossed with a non-slip surface, colour, pattern, or combinations thereof. The capstock 180 may improve the bending strength of the building material 100. For example, if a 2 inch capstock 180 is provided to the building material 100, the capstock 180 may impart rigidity to the building material 100 due to the additional thickness of the building material 100. The capstock 180 may also be useful in trapping odors emitted from the building material 100.

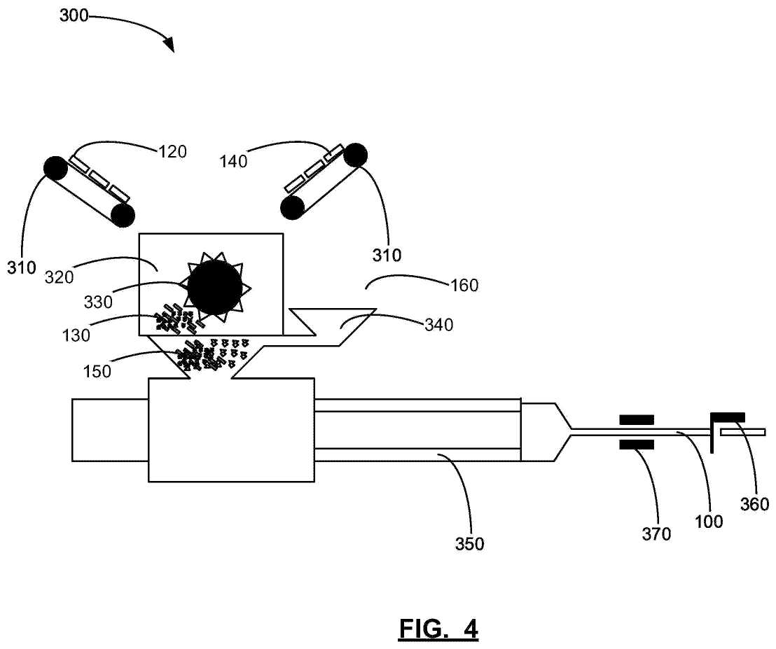

Referring now to FIG. 4, shown therein is an example of a system 300 for manufacturing the building material 100. As shown, the system 300 may include a plurality of conveyers 310 for supplying a hopper 320 with materials. The hopper 320 may feed into a shredder 330. Another hopper 340 may be used to supply additional materials to the mixture. The materials are provided to an extruder 350, which operates to extrude the combined materials into the building material 100. The system 300 may include a cutting device 360 for cutting the building material 100 into a desired shape and/or size. In some examples, the system 300 may also include a cooling device 370 for cooling the extruded material.

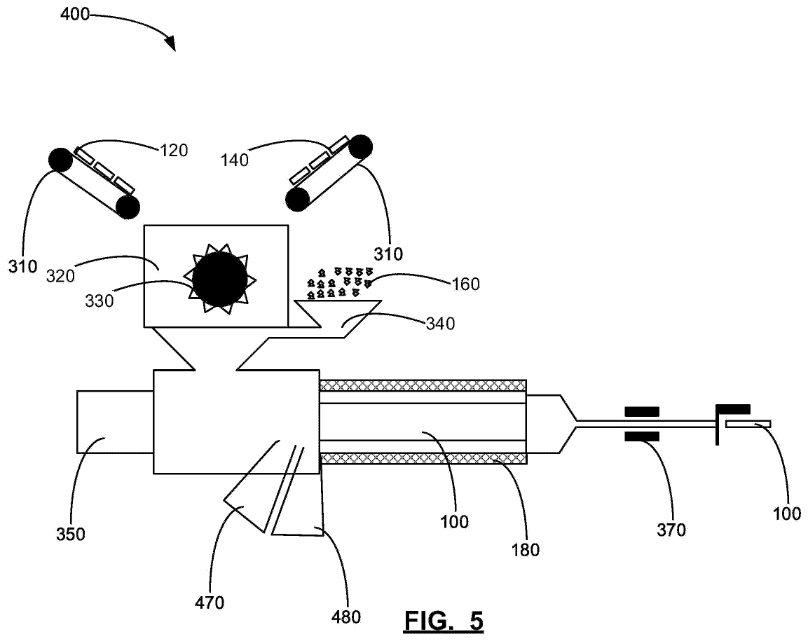

Referring now to FIG. 5, shown therein is another example of a system 400. System 400 includes the same components as system 300, but also includes an adhesive applicator 470 and an encapsulator 480. The adhesive applicator 470 and the encapsulator 480 may operate to provide the capstock 180 to the building material 100.

The process of manufacturing the building material 100 will now be discussed in further detail.

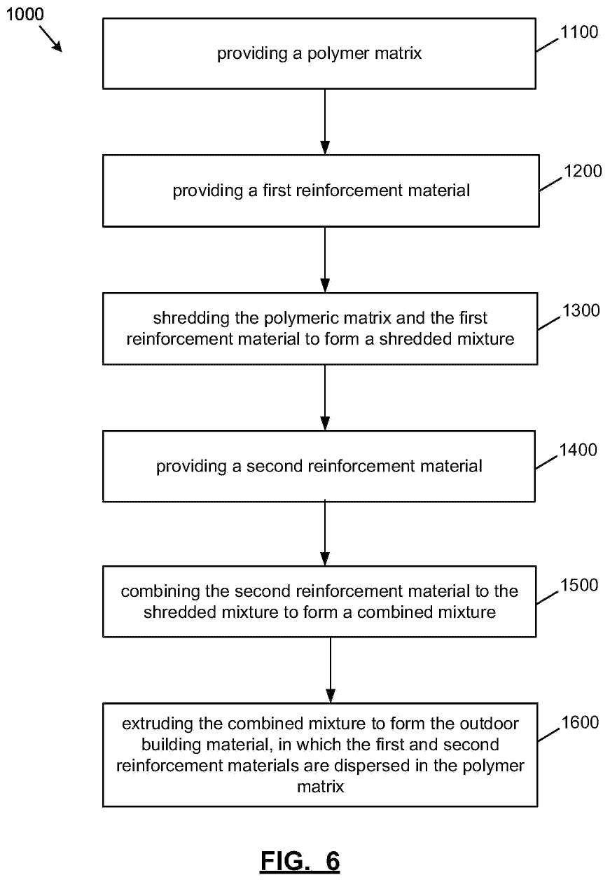

Referring to FIG. 6, shown therein is a flow chart illustrating an exemplary method 1000 of manufacturing the building material 100. At step 1100, the polymer matrix 120 is provided. As shown in FIG. 4, the polymer matrix 120 may be provided to the hopper 340.

At step 1200, the first reinforcement material 140 is provided. As shown in FIG. 4, the polymer matrix may be provided to the hopper 320.

The hopper 320 may feed into the shredder 330. At step 1300, the polymer matrix 120 and the first reinforcement material 140 may be shredded to form a shredded mixture 130. After shredding the first reinforcement material 140, the first reinforcement material 140 may be in the form of pieces having length, width, and height dimensions each between about 0.25 inch to about 1 inch. The first reinforcement material 140 may be shredded into flakes and/or fibers. The shredded mixture 130 may be passed from the shredder 330 to the second hopper 340.

At step 1400, the second reinforcement material 160 may be provided. As shown in FIG. 4, the second reinforcement material 160 may be provided to the second hopper 340.

At step 1500, the shredded mixture 130 may be combined with the second reinforcement material 160 to form a combined mixture 150. The combined mixture 150 may pass from the hopper 340 to the extruder 350. When in the extruder 350, the extruder 350 may heat the combined mixture 150. The extruder 350 may operate at a temperature such that the polymer matrix 120 is melted. In some examples, the extruder 350 may operate at a temperature that is above the melting temperature of the polymer matrix 120 and below the melting temperature of the first reinforcement material 140.

At step 1600, the combined mixture 150 may be extruded to form the outdoor building material 100. As exemplified in FIGS. 1-3, the first reinforcement material 140 and the second reinforcement material 160 are dispersed in the polymer matrix 120 to form the building material 100.

In some examples, the building material 100 may be co-extruded with a capstock 180. The capstock may be formed of HDPE, PET, PVC, or combinations thereof. As exemplified in FIG. 5, the system 400 may operate to use the adhesive applicator 470 and the encapsulator 480 to adhere the capstock 180 to the extruded combined mixture 150. For example, the tie layer 170 may be adhesive between the capstock 180 and the extruded combined mixture 150. In some examples, the capstock 180 may be embossed with a non-slip surface, colour, pattern, or combinations thereof.

The extruder 350 may be any device capable of extruding the materials of the building material 100. For example, as shown in FIGS. 4 and 5, the extruder 350 is a single-screw extruder. Single-screw extruders may be more easily coated with a carbide and/or tungsten than twin-screw extruders, thereby improving the wear of the extruder 350. Improving the wear of the extruder 350 may allow for materials that have a higher amount of contaminants without requiring that the materials be washed prior to use. For example, if agricultural waste is used as the polymer matrix and is not washed prior to use, sand and/or other contaminants may be present in the mixture. A tungsten-coated extruder reduces the wear of the extruder due to abrasion from the contaminants. In contrast, a twin-screw extruder may require additional levels of washing and contaminate separation due to the increased wear between the two screws. Furthermore, when textile fibers are used as the first reinforcement material 140, a single-screw extruder may reduce the likelihood of damaging the textile fibers, whereas twin-screw extruders may damage the textile fibers as the material is passed between the two screws.

Single-screw extruders may also operate with lower shear, which allows for the provision of a lower density material. The low density material is less likely to be over heated in the extruder due to the reduced shear. As described previously, having a consistent temperature in the extruder may prevent the first reinforcement material 140 from being unintentionally melted, thereby providing a more consistent building material 100. Additionally, since the polymer matrix 120 and first reinforcement material 140 may be shredded together at step 1300, the shredded mixture 130 may be sufficiently mixed prior to entering the extruder 350. Accordingly, additional mixing as a result from the use of a twin-screw extruder is not necessary to sufficiently mix the combined mixture 150.

As described previously, the second reinforcement material 160 may be char. Char may operate to remove odors from the building material 100. Accordingly, when the first reinforcement material 140 is a textile, such as clothing, the textile does not need to be washed prior to being combined with the polymer matrix 120. Since the textile does not need to be washed, the textile may be combined with the polymer matrix 120 and shredded simultaneously with the polymer matrix 120. Shredding the polymer matrix 120 and the textile together may allow for additional materials to be used as the polymer matrix 120. In some examples, the polymer matrix 120 may be derived from agricultural film. Agricultural film used to secure baled silage, otherwise known as stretch film, can be a difficult material to grind since it contains a tackifier. By shredding the agricultural film simultaneously with the textile, the textile may step to keep the shredded particles of the agricultural film separate from one another, thereby improving the mixing of the different components before they are sent to the extruder 350. Improving the mixing of the different components may improve the consistency of the extruded building material 100.

In some examples, the polymer matrix 120 and/or the first reinforcement material 140 may be washed before being shredded. For example, if the reinforcement material 140 is derived from post-consumer waste that is particularly contaminated (e.g., old carpets), it may be desirous to remove impurities through washing prior to extruding the materials. Similarly, if the polymer matrix 120 is selected from agricultural waste that has organic matter, rocks, metal, and/or sand, the contaminants may be separated from the agricultural film in a liquid bath or a cyclone prior to being used.

In some examples, the combined mixture 150 may be die-cast or pressed instead of being extruded.

While the above description provides examples of one or more apparatuses or methods, it will be appreciated that other apparatuses or methods may be within the scope of the accompanying claims.

We claim:

1. A method of manufacturing an outdoor building material, comprising:
providing a polymer matrix;
providing a first reinforcement material;
shredding the polymeric matrix and the first reinforcement material to form a shredded mixture;
providing a second reinforcement material;
combining the second reinforcement material to the shredded mixture to form a combined mixture; and
extruding the combined mixture to form the outdoor building material, in which the first and second reinforcement materials are dispersed in the polymer matrix.

2. The method of claim 1, wherein the polymer matrix comprises at least one polyolefin and/or copolymers thereof.

3. The method of claim 2, wherein the at least one polyolefin is polyethylene (PE), low-density polyethylene (LDPE), high-density polyethylene (HDPE), linear low-density polyethylene (LLDPE), polypropylene (PP), ethyl vinyl acetate (EVA), copolymers thereof, and/or combinations thereof.

4. The method of claim 3, wherein the polymer matrix comprises polystyrene (PS), high impact polystyrene (HIPS), polyvinyl chloride (PVC), acrylic, acrylonitrile butadiene styrene (ABS), copolymers thereof, and/or combinations thereof.

5. The method of claim 1, comprising deriving at least a portion of the polymer matrix from waste agricultural film.

6. The method of claim 1, wherein the first reinforcement material consists of a textile material.

7. The method of claim 6, wherein:
at least a portion of the first reinforcement material is post-consumer waste in the form of clothing, carpet, curtains, fabric, or combinations thereof;
the textile material comprises at least one of polyethylene terephthalate (PET), polypropylene (PP), nylon, and cotton;
after the step of shredding, the textile material is in the form of at least one of flakes and fibers; and/or
after the step of shredding, the textile material is in the form of pieces having length, width and height dimensions each between about 0.25 inch to about 1 inch.

8. The method of claim 1, wherein the second reinforcement material consists of at least one of char, biochar, and carbon black.

9. The method of claim 1, comprising providing a third reinforcement material for the combined mixture.

10. The method of claim 9, wherein the third reinforcement material consists of high-density polyethylene (HDPE) derived at least partially from post-consumer waste.

11. The method of claim 1, wherein the polymer matrix comprises a compatibilizer selected from polyisobutylene, polyisoprene, LLDPE comprising a tackifier, or combinations thereof.

12. The method of claim 1, comprising an additive selected from a foaming agent, a moisture absorbing material, a material for wettability, a flame retardant, or combinations thereof.

13. The method of claim 12, wherein the additive comprises:
the foaming agent, and the foaming agent is sodium bicarbonate, liquid natural gas, pentane, nitrogen, carbon dioxide, or combinations thereof;
the moisture absorbing material, and the moisture absorbing material is calcium oxide, calcium carbonate, or combinations thereof;
the material for wettability, and the material for wettability is polyisobutylene, epoxidized soybean oil, polyglycol, phosphate, borate, or combinations thereof; and/or
the flame retardant, and the flame retardant is phosphate, borate, or combinations thereof.

14. The method of claim 1, wherein step of shredding comprises shredding the polymeric matrix and the first reinforcement material together in a shredder.

15. The method of claim 1, comprising washing at least one of the polymeric matrix and the first reinforcement material before the step of shredding.

16. The method of claim 1, wherein the step of extruding comprises:
using a single screw extruder;
heating the combined mixture; and/or
melting the polymer matrix.

17. The method of claim 1, comprising co-extruding a capstock formed of HDPE, PET, PVC, PS, HIPS, ABS, nylon, polyacrylate, methacrylate, copolymers thereof, and/or combinations thereof.

18. The method of claim 17, comprising co-extruding a tie layer to improve adhesion between the capstock and the polymer matrix, and wherein the tie layer comprises an adhesive.

19. A method of manufacturing an outdoor building material, comprising:
providing a polymer matrix, at least a portion of which is derived from waste agricultural film;
providing a first reinforcement material, at least a portion of which is derived from post-consumer waste in the form of clothing, carpet, curtains, fabric, or combinations thereof;
shredding the polymeric matrix and the first reinforcement material to form a shredded mixture;
providing a second reinforcement material comprising char, biochar, carbon black, or combinations thereof;
combining the second reinforcement material to the shredded mixture to form a combined mixture; and
heating and extruding the combined mixture to form the outdoor building material, in which the first and second reinforcement materials are dispersed in the polymer matrix.

20. An outdoor building material, comprising:
a polymer matrix;
a first reinforcement material dispersed in the polymer matrix; and
a second reinforcement material dispersed in the polymer matrix,
wherein the first reinforcement material consists of a textile material, and
wherein the second reinforcement material consists of at least one of char, biochar, and carbon black.
